(19) United States
(12) Patent Application Publication
(10) Pub. No.: US 2023/0222332 A1
(43) Pub. Date: Jul. 13, 2023

(54) Advanced Neural Network Training System

(71) Applicant: GM Cruise Holdings LLC, SAN FRANCISCO, CA (US)

(72) Inventors: Siddharth Mahendran, Mountain View, CA (US); Teng Liu, Jersey City, NJ (US); Yong Jae Lee, Walnut Creek, CA (US); Marzieh Parandehgheibi, SAN FRANCISCO, CA (US)

(21) Appl. No.: 17/554,858

(22) Filed: Dec. 17, 2021

(51) Int. Cl. G06N 3/08; G06N 3/045; B60W 50/06

(52) U.S. Cl. CPC G06N 3/08; G06N 3/045; B60W 50/06; B60W 60/001

(57) ABSTRACT

Disclosed are systems, apparatuses, methods, and computer-readable media to train a neural network model implemented into a perception stack in an autonomous vehicle (AV) for detecting objects. A method includes pretraining an uninitialized ML model to yield a first ML model; training the first ML model with a first testing dataset for a first number of iterations based on a first configuration; analyzing the first ML model based on a convergence of the first ML model and a previous iteration of training; generating a report based on the analysis of the first ML; and after generating the report, training the first ML model to yield a second ML model.

### TECHNICAL FIELD

The subject technology is related to autonomous driving vehicles and, in particular, for training a neural network to be used in autonomous driving vehicles.

### BACKGROUND

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide safe and efficient transportation. Such tasks may require the collection and processing of large quantities of data disposed on the autonomous vehicle.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of an autonomous vehicle (AV) management system according to an example of the instant disclosure;

FIG. 2 illustrates an example diagram of a Continuous Learning Machine (CLM) for resolving uncommon scenarios in an AV according to an example of the instant disclosure;

FIG. 3 illustrates an example lifecycle of a machine learning (ML) model according to an example of the instant disclosure;

FIG. 4 illustrates an advanced training system for training ML models that is implemented by a model service and a model evaluation service according to an example of the instant disclosure;

FIG. 5 illustrates an example method of an advanced training system for training an ML model according to an example of the instant disclosure;

FIG. 6 illustrates an example method for revising an ML model based on a compute budget of an AV according to an example of the instant disclosure; and

FIG. 7 illustrates an example of a computing system according to an example of the instant disclosure.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### OVERVIEW

Systems, methods, and computer-readable media are disclosed for training a neural network model that facilitates convergence and modification of the neural network model during training and evaluation. Data and annotations are important to successful training and evaluation of a neural network, but adding more data increases compute time and does not necessarily guarantee improved accuracy. There is also a benefit to deploying a neural network model faster to reduce the time between an observation that cannot be resolved by the neural network model and creating a new neural network model that can handle scenarios that correspond to that observation. For example, an autonomous vehicle (AV) may experience different scenarios based on its operating environment (e.g., urban, rural, time, etc.) and different neural network models may be needed for each different operating environment.

A training method is disclosed to improve the data selection and model training processes to reduce training time while maintaining performance of the machine learning (ML) model. The method includes pretraining an uninitialized ML model to yield a first ML model, training the first ML model with a first testing dataset for a first number of iterations based on a first configuration, analyzing the first ML model based on a convergence of the first ML model with respect to a validation dataset and analyzing the first ML model based a previous iteration of training. The method can include generating a report, which can be used in a semi-supervised operation (e.g., by a combination of automated and manual operations) to at least one of modify the ML model and select different data to focus training (e.g., a curriculum of materials for the ML model to learn).

### EXAMPLE EMBODIMENTS

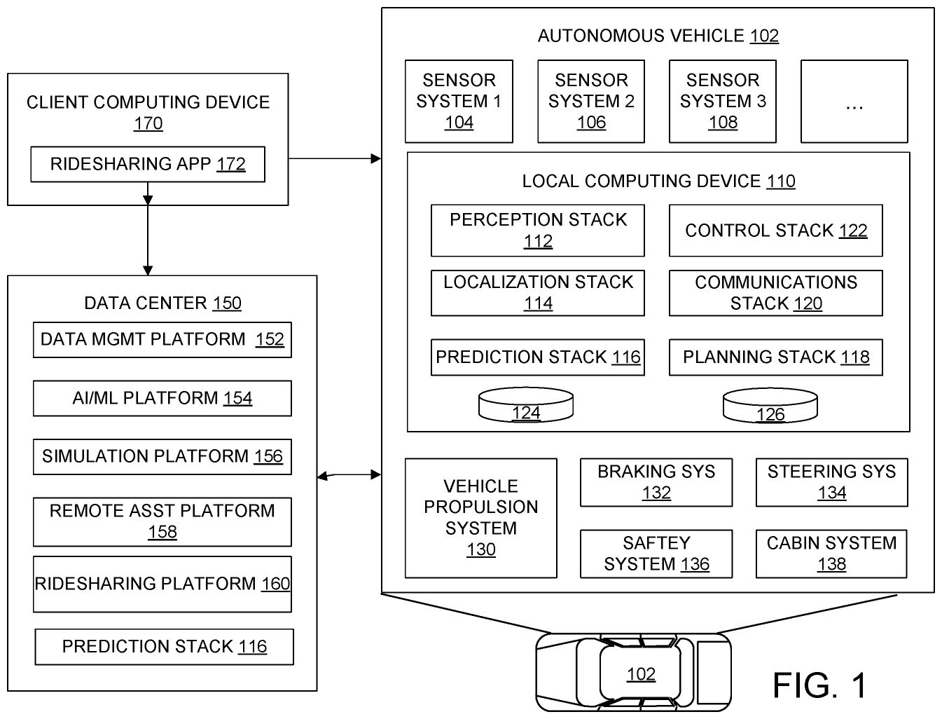

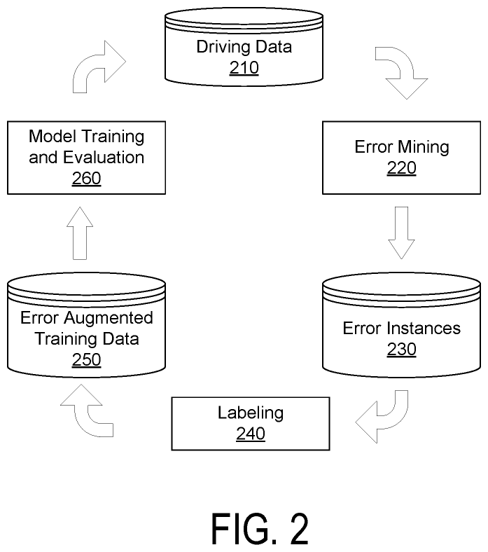

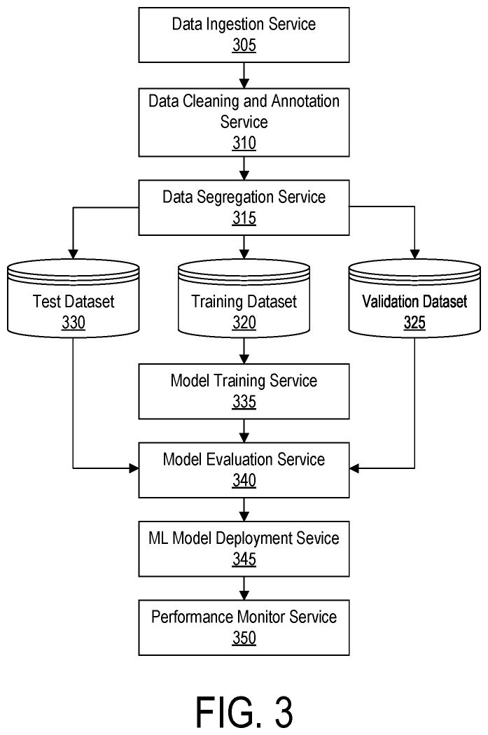

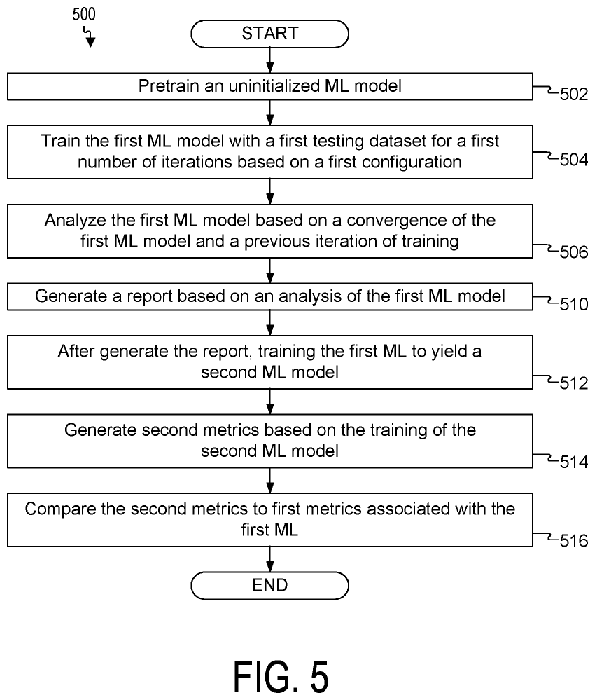

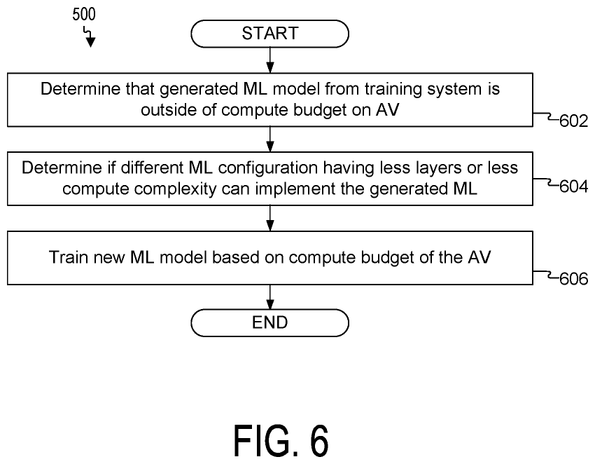

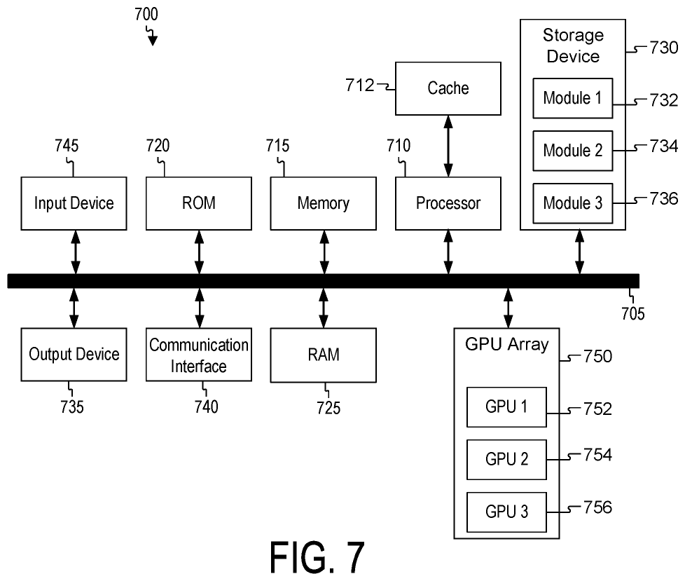

A description of an AV management system and a continual learning machine (CLM) for the AV management system, as illustrated in FIGS. 1 and 2, are first disclosed herein. An overview of a neural network lifecycle is disclosed in FIG. 3 and is followed by an advanced training system for training ML models. Methods to train a neural network are then disclosed in FIGS. 5 and 6. The discussion then concludes with a brief description of example devices, as illustrated in FIG. 7. These variations shall be described herein as the various embodiments are set forth. The disclosure now turns to FIG. 1.

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light ranging and detection (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a high definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence (AI)/ML (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

FIG. 2 illustrates an example diagram of a CLM 200 that solves long-tail prediction problem in an AV in accordance with some examples. The CLM 200 is a continual loop that iterates and improves based on continual feedback to learn and resolve driving situations experienced by the AV.

The CLM 200 begins with a fleet of AVs that are outfitted with sensors to record a real-world driving scene. In some cases, the fleet of AVs is situated in a suitable environment that represents challenging and diverse situations such as an urban environment to provide more learning opportunities. The AVs record the driving situations into a collection of driving data 210.

The CLM 200 includes an error mining 220 to mine for errors and uses active learning to automatically identify error cases and scenarios having a significant difference between prediction and reality, which are added to a dataset of error instances 230. The error instances are long-tail scenarios that are uncommon and provide rich examples for simulation and training. The error instances 230 store high-value data and prevent storing datasets with situations that are easily resolved.

The CLM 200 also implements a labeling function 240 that includes both automated and manual data annotation of data that is stored in error augmented training data 250 and used for future prediction. The automated data annotation is performed by an ML labeling annotator that uses a neural network trained to identify and label error scenarios in the datasets. Using the ML labeling annotator enables significant scale, cost, and speed improvements that allow the CLM 200 to cover mores scenario of the long tail. The labeling function 240 also includes functionality to allow a human annotator to supplement the ML labeling function. By having both an automated ML labeling function and a manual (human) labeling annotator, the CLM 200 can be populated with dense and accurate datasets for prediction.

The final step of the CLM 200 is model training and evaluation 260. A new model (e.g., a neural network) is trained based on the error augmented training data 250 and the new model is tested extensively using various techniques to ensure that the new model exceeds the performance of the previous model and generalizes well to the nearly infinite variety of scenarios found in the various datasets. The model can also be simulated in a virtual environment and analyzed for performance. Once the new model has been accurately tested, the new model can be deployed in an AV to record driving data 210. The CLM 200 is a continual feedback loop that provides continued growth and learning to provide accurate models for an AV to implement.

In practice, the CLM can handle many uncommon scenarios, but the AV will occasionally need to account for new and infrequency scenarios that would be obvious to a human. For example, an AV may encounter another motorist making an abrupt and sometimes illegal U-turn. The U-turn can be at a busy intersection or could be mid-block, but the U-turn will be a sparse data point as compared to more common behaviors such as moving straight, left turns, right turns, and lane changes. Applying our CLM principles, an initial deployment model may not optimally predict U-turn situations and error situations commonly include U-turns. As the dataset grows and more error scenarios of U-turns are identified, the model can be trained to sufficiently predict a U-turn and allow the AV to accurately navigate this scenario.

The CLM 200 can be applied to any number of scenarios that a human will intuitively recognize including, for example, a K-turn (or a 3-point turn), lane obstructions, construction, pedestrians, animated objects, animals, emergency vehicles, funeral processions, jaywalking, and so forth. The CLM 200 provides a mechanism for continued learning to account for diverse scenarios that are present in the physical world.

FIG. 3 illustrates an example lifecycle 300 of a ML model in accordance with some examples. The first stage of the lifecycle 300 of a ML model is a data ingestion service 305 to generate datasets described below. ML models require a significant amount of data for the various processes described in FIG. 3 and the data persisted without undertaking any transformation to have an immutable record of the original dataset. The data itself can be generated by sensors attached to an AV, for example, but can also be provided from third party sources such as publicly available dedicated datasets used for research purposes. The data ingestion service 305 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data (e.g., an AV) from the consumer of the data (e.g., an ML model training pipeline). For offline data production, when source data is available from the producer (e.g., the AV), the producer publishes a message and the data ingestion service 305 retrieves the data. In some examples, the data ingestion service 305 may be online and the data is streamed from the producer (e.g., the AV) in real-time for storage in the data ingestion service 305.

After data ingestion service 305, a data preprocessing service preprocesses the data to prepare the data for use in the lifecycle 300 and includes at least data cleaning, data transformation, and data selection operations. The data preprocessing service 310 removes irrelevant data (data cleaning) and general preprocessing to transform the data into a usable form. In some examples, the data preprocessing service 310 may convert three-dimensional (3D) LIDAR data (e.g., 3D point cloud data) into voxels. The data preprocessing service 310 includes labelling of features relevant to the ML model such as people, vegetation, vehicles, and structural objects in the case of an AV. In some examples, the data preprocessing service 310 may be a semi-supervised process performed by a ML to clean and annotate data that is complemented a manual operations such as labeling of error scenarios, identification of untrained features, etc.

After the data preprocessing service 310, data segregation service 315 to separate data into at least a training dataset 320, a validation dataset 325, and a test dataset 330. Each of the training dataset 320, a validation dataset 325, and a test dataset 330 are distinct and do not include any common data to ensure that evaluation of the ML model is isolated from the training of the ML model.

The training dataset 320 is provided to a model training service 335 that uses a supervisor to perform the training, or the initial fitting of parameters (e.g., weights of connections between neurons in artificial neural networks) of the ML model. The model training service 335 trains the ML model based a gradient descent or stochastic gradient descent to fit the ML model based on an input vector (or scalar) and a corresponding output vector (or scalar).

After training, the ML model is evaluated at a model evaluation service 340 using data from the validation dataset 325 and different evaluators to tune the hyperparameters of the ML model. The predictive performance of the ML model is evaluated based on predictions on the validation dataset 325 and iteratively tunes the hyperparameters based on the different evaluators until a best fit for the ML model is identified. After the best fit is identified, the test dataset 330, or holdout data set, is used as a final check to perform an unbiased measurement on the performance of the final ML model by the model evaluation service 340. In some cases, the final dataset that is used for the final unbiased measurement can be referred to as the validation dataset and the dataset used for hyperparameter tuning can be referred to as the test dataset.

After the ML model has been evaluated by the model evaluation service 340, a ML model deployment service 345 can deploy the ML model into an application or a suitable device. The deployment can be into a further test environment such as a simulation environment, or into another controlled environment to further test the ML model. In the case of an AV, the ML model would need to undergo further evaluation inside a simulated environment and, after further validation, could be deployed in the AV. In some examples, the ML model could be implemented as part of the perception stack 112 to detect objects.

After deployment by the ML model deployment service 345, a performance monitor service 350 monitors for performance of the ML model. In some cases, the performance monitor service 350 can also record performance data such as driving data that can be ingested via the data ingestion service 305 to provide further data, additional scenarios, and further enhance the training of ML models.

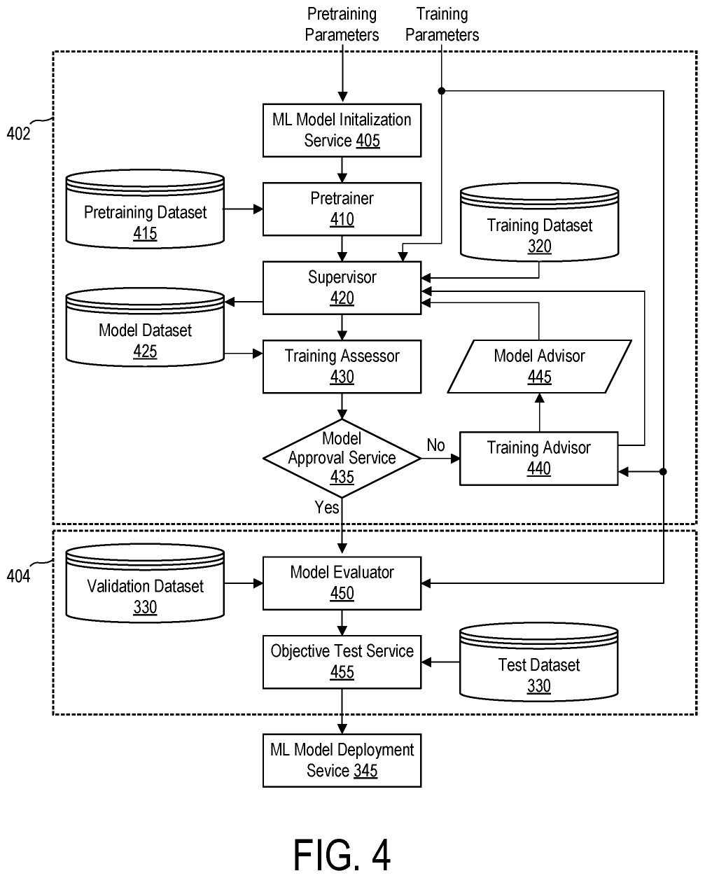

FIG. 4 illustrates an advanced training system 400 for training ML models that is implemented by a model training service 402 and a model evaluation service 404 according to an example of the instant disclosure. The disclosed advanced training system provides a framework for incrementally training a deep neural network and provides various types of learning to increase training time and improve learning efficiency. In the AV environment, there is a large emphasis on providing massive amounts of data to train the deep neural networks for the variety to ML tasks for perception and prediction. Conventionally, data mining has been used to prune low value to data to create a mixture of both low, medium, and high value data. These large data values increase the training time which slows the iterative research and development cycles.

The model training service 402 includes an ML model initialization service 405 that initializes an untrained ML model based on a set of input pretraining parameters. The input pretraining parameters can include, for example, information related to architecture (e.g., visual geometry group neural network (VGGnet), residual neural network (ResNet), feature pyramics network (FPN), Bi-FPN, deep layer aggregation network (DLA) etc.), the number of layers, the number of connections between layers, etc. The ML model initialization service 405 initializes a suitable model based on a specific task and may not necessarily be limited by the compute budget while deployed on an AV (e.g., AV 102). In some examples, the untrained ML model can be used for any suitable prediction task such as semantic segmentation, object tracking and prediction, etc.

The untrained ML model is provided to a pretrainer 410 that pretrains the ML model with data provided from a pretraining dataset 415. The pretraining dataset 415 may be curated based on previous training iterations that yield quick ML model convergence to provide a known start point while eliminating early uninformed training decisions. In some examples, pretraining parameters input into the model training service 402 can be used by the pretrainer 410 to select a relevant set of data within the pretraining dataset 415. In some examples, the pretraining data parameters can be a list of annotations, explicit identifiers associated with particular content, or other parameters that filter the pretraining dataset 415 to provide relevant data for the pretrainer 410.

The pretrained ML model is provided to a supervisor 420 for training based on data provided from the training dataset 320 and based on one or more training parameters input into the model training service 402. The training parameters provide criteria and base information such as an initial ML model, layers, and can include information that the supervisor 420 uses select suitable data during training from the training dataset 320. The supervisor 420 trains the ML model at least one iteration based on data selected in the training dataset 320 and records information in a model dataset 425 related to the training such as identification of scenarios that the ML resolved or did not resolve, performance parameters, as well as any relevant statistical information of the ML model. The model dataset 425 is used to analyze performance of the training to identify different scenarios that have been resolved, performance metrics, and so forth to facilitate training.

After at least one iteration of training by the supervisor 420, the ML model trained by the supervisor 420 is provided to a training assessor 430 that assesses the current training of the ML model based on a comparison to information in the model dataset 425 as well as objective information related to convergence, ML model performance, and so forth. In some examples, the training assessor 430 identifies negative and positive training effects such as forgetting, which is when a previously resolved scenario becomes unresolved during training. In some examples, this could be an effect of over-fitting, an architecture issue, or a data diversity issue. The training assessor 430 can also benchmark and profile the training performed by the supervisor 420 based on metrics in the model dataset 425 from previous iterations (e.g., earlier epochs), etc.

A model approval service 435 receives the trained ML model and the training assessment from the training assessor 430 and determines when the initial training of the ML model meets a criterion for proceeding to the model evaluation service 404. In some examples, the training data parameters may also include validation tests that the model approval service 435 can use to validate the initial training of the ML model.

If the training ML model is not approved, the ML model and relevant data (e.g., training parameters, training assessment information, ML model information from the model dataset 425, etc.) are provided to a training advisor 440. The training advisor 440 analyzes the various information to generate a report for feedback into the model training service 402 to supervised learning. In some examples, the training advisor 440 can identify various constraints in the model training service 402 that are delaying training or reducing the effectiveness of the training. Some example categories of constraints include model capacity (e.g., when the model size limits the amount of information the ML model can learn), forgetting learned scenarios (e.g., by adding difficult to resolve scenarios, the ML model can forget prior scenarios), data category imbalance (e.g., too much vehicular data for a sparsely populated scenario, etc.), scenario imbalance (e.g., easy to drive scenarios dominate the data compared to very limited hard scenarios), model architecture feedback that identifies that the model is not suitable for task or object properties (e.g., scale, orientation, keypoints, etc.), data diversity information that provides feedback regarding data (e.g., too limited data diversity, value of each frame in the training data, etc.), evaluation metrics that identify whether the correct metrics with respect to feature sets and scenarios of interest (e.g., are the measurements biased towards either easy or hard scenarios), and optimization metrics.

In some examples, the training advisor 440 identifies a metric associated with each constraint and maps various scenarios to training data to quantity constraints and may execute a series of tests on different axes of the training data to map scenarios to one or more constraints.

The training advisor 440 can enable semi-supervised learning by automatically adjusting parameters from the training advisor 440 or by creating a report for a human operator that can use to tune the model training service 402. In some examples, the training advisor 440 provides feedback information to at least one of a model advisor 445 and the supervisor 420 to inform model mutation and data selection while training by the supervisor 420.

In some examples, the training advisor 440 can provide guidance to the supervisor 420 to prioritize specific types of data (e.g., annotations). The supervisor 420 will then prioritize the training (e.g., the weights and means) based on that specific type of data. By prioritizing specific types of data, the advanced training system 400 allows the training to occur on a smaller subset and will reduce time to train the ML model. This example can also be used in a curriculum to identify easy objects and then train on progressively harder objects to refine the ML model.

The model advisor 445 uses the information recorded within the model training service 402 to revise the ML model and provide recommendations to revise the ML model. The model advisor 445 may determine, for example, backpropagation is affecting training and may implement at least one layer that uses a shortcut connection (e.g., a residual connection) that simplifies backpropagation. In some examples, the model advisor 445 can determine if additional layers are needed or if data from low-resolution, high resolution, or sematic features is needed to improve training. For example, the model advisor 445 may determine that parallelization of the layers would benefit the identification of a different set of labels.

In some examples, the model advisor 445 can be configured to dynamically construct code to be executed in the supervisor 420 by construction generic interfaces, dependency injection, and other polymorphic procedures that provide an abstraction layer to dynamically implement the ML model. As the model advisor 445 modifies the ML model based on input and feedback from the training advisor, the model dataset 425 can record relevant information to allow the training assessor 430 to assess changes. In some examples, the model dataset 425 can store the ML model and use a proxy object to track changes and performance of the object to provide a comprehensive ability to benchmark the ML model as it changes during training in the model training service 402. In some examples, the model advisor 445 may be a semi-supervised process and a manual operator may be needed to input various parameters. A visitor pattern or other suitable dynamic pattern to dynamically generate instruction can be implemented in the model advisor 445 to receive the input parameters from a human operator and generate a concrete implementation (e.g., Python code) using the generic interfaces, dependency injection, and other polymorphic procedures. The model advisor 445 provides the modified ML model back to the supervisor 420 for another iteration of training (e.g., epoch).

The training advisor 440 can also receive the input training parameters and implement a curriculum for the ML model to sequentially learn. For example, the training advisor 440 cause the supervisor 420 to train the ML model with a first training dataset that includes a broader category of labels (e.g., vehicles) and subsequently train the ML model a second training dataset that includes subsets of the broader category (e.g., bicycle, scooter, light truck, heavy truck, bus, etc.). In this example, the training advisor 440 is configured to ensure that the scenarios associated with the first training dataset are not forgotten (e.g., cannot be resolved) after training the second training dataset.

After the model approval service 435 approves the ML model generated by the model training service 402, the ML model is provided to the model evaluation service 404 for evaluation and testing. A model evaluator 450 receives the ML model and performs an iterative evaluation using the validation dataset 325. The model evaluator 450 may also receive the input training parameters and select a subset of the validation dataset 325 based on the training parameters. The training parameters may also identify one or more evaluators that the model evaluator 450 performs and the model evaluator 450 then tunes the hyperparameters of the ML model to achieve an optimum performance of the final ML model.

The final ML model provided by the model evaluator 450 is provided to an objective test service 455 that performs a final, objective set using the test dataset 330. The objective test service 455 provides a final benchmark that can be used to evaluate the ML model after deployment by the ML model deployment service 345.

FIG. 5 illustrates an example method 500 of an advanced training system for training an ML model according to an example of the instant disclosure. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

The method 500 can be performed by a distributed system comprising at least one computing system 700 illustrated in FIG. 7. Although the method can be performed by a single computing system 700 based on current training processes, the method is typically performed by a massive parallel system comprising many computing systems 700. Different portions of the computing system 700 can perform suitable tasks of the method 500. For example, portions of the method 500 related to selecting data from the various datasets may be performed by the processor 710 and portion of the method 500 related to training the ML and performing many mathematical operations may be performed by a graphical processing unit (GPU) array 750. In some examples, the operations may be implemented by a model training service 402 executing on the computing system 700.

According to some examples, the method includes training the first ML model with a first testing dataset for a first number of iterations based on a first configuration at block 504. For example, the GPU array 750 may train the first ML model with a first testing dataset for a first number of iterations based on a first configuration and with a first testing dataset.

According to some examples, the method includes analyzing (e.g., by the GPU array 750) the first ML model based on a convergence of the first ML model and based a previous iteration of training at block 506.

In a first example of block 506, the analyzing the first ML model may be implemented by determining (e.g., by the GPU array 750 or the processor 710) an impact of the first testing dataset based on the convergence. After determining the impact, the method 500 can (e.g., by the GPU array 750 or the processor 710) identify discrete portions of the first testing dataset having a high impact on the convergence.

In a second example of block 506, the analyzing the first ML model may be implemented by determining an impact of the first testing dataset based on the convergence and identifying (e.g., by the GPU array 750 or the processor 710) discrete portions of the first testing dataset causing the convergence to underperform. The discrete portions of the first testing dataset cause the convergence to underperform based on a volume of data used in the training and an extra compute time. In some examples, noise in annotations in the first testing dataset causes the convergence to user-perform.

After block 506, the method 500 includes generating (e.g., by the processor 710) a report at block 510. In some examples, the report can identify discrete portions of a dataset that were used in the training in block 506. The report identifies at least one information group that identifies at least one constraint detected during the training. The at least one information group comprises at least one of a model capacity, a learning category, a scenario imbalance, a target category imbalance, model information, data diversity information, evaluation information, and optimization information.

After generating the report, the method includes training (e.g., by the GPU array 750) the first ML model to yield a second ML model at block 512. The second ML model is trained based on a second configuration that is different than the first ML model. For example, the second ML can have additional layers, different connections, and so forth. In some examples, block 512 may further include operations to identify at least one annotation in the first testing dataset set to emphasize. A ML model trainer (e.g., supervisor 420) that performs each iteration of the training receives the identification of the annotations to emphasize. In another example of block 512, the training of the first ML model with a second training dataset is based on the identification of annotations to emphasize.

In another example of block 512, block 512 may be implemented by generating a second training dataset and a third training dataset based on a curriculum for the first ML model to learn. The second training dataset comprises a first scenario to learn first and the third training dataset comprises at least one scenario of the first scenario. For example, the first scenario can be a lateral object movement and scenarios of the first scenario can be lateral bicycle movement, train movement at a railroad crossing, etc. In this example, block 512 further includes training the first ML model with the second training dataset and then training the first ML model with a third dataset.

After block 512, the method 500 includes generating (e.g., by the processor 710) second metrics based on the training of the second ML model at block 514.

According to some examples, the method includes comparing (e.g., by the processor 710) the second metrics to first metrics associated with the first ML model at block 516. In one example, the comparison allows iterative analysis of each ML model and in some cases can determine that a first scenario in the first ML model is unresolved in the second ML model. For example, the first metrics identify that the first scenario was resolved in the first ML model and, therefore, the second ML has forgotten the first scenario.

In some examples, the training continues based on the above-described operations until there is convergence in the ML model and the training stops.

In some examples, the method 500 further includes training a third ML model from the second ML model based on a compute budget associated with an AV with a second testing dataset at block 518.

FIG. 6 illustrates an example method 600 for revising an ML model based on a compute budget of an AV according to an example of the instant disclosure. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 500 may perform functions at substantially the same time or in a specific sequence. As described above, the operations described in the method 600 can be performed in a distributed system implemented by at least one computing system 700.

The method 600 starts by determining whether the generated ML model (e.g., the model generated by the method 500) is outside of a compute budget of associated devices in the AV (e.g., the perception stack 112) at block 602. The method 600 then determines if a different ML configuration having less layers or less compute complexity can implement the generated ML model at block 604. The more layers, the more complex the compute. For example, a 23-layer VGGnet will have more calculations than a 9-layer VGGnet. In some cases, a ResNet architecture can have simpler calculations than a VGGnet based having fewer fully connected layers at the output. At block 606, the method rains a new ML model based on the compute budget of the AV. For example, block 606 can include teacher-student distillation to reduce the complexity of a model so that the AV can implement the trained ML model within its constraints.

Example computing system 700 includes at least one processing unit (CPU or processor) 710 and connection 705 that couples various system components including system memory 715, such as read-only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control the processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, RAMs, ROM, and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

The computing system 700 can also include a GPU array 750 or any similar processor for performing massively complex and parallel mathematical operations such as simulations, games, neural network training, and so forth. The GPU array 750 includes at least one GPU and is illustrated to have three GPUs comprising GPU 752, GPU 754, and GPU 756. However, the GPU array 750 can be any number of GPUs. In some examples, the GPU core can be integrated into a die of the processor 710.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method of training a machine learning (ML) model, the method comprising: pretraining an uninitialized ML model to yield a first ML model; training the first ML model with a first testing dataset for a first number of iterations based on a first configuration; analyzing the first ML model based on a convergence of the first ML model and a previous iteration of training; generating a report based on the analysis of the first ML; and after generating the report, training the first ML model to yield a second ML model.

Aspect 2. The method of Aspect 1, wherein training of the first ML model is performed with a second testing dataset.

Aspect 3. The method of any of Aspects 1 to 2, wherein analyzing the first ML model based on the convergence of the first ML model comprises: determining an impact of the first testing dataset based on the convergence; and identifying discrete portions of the first testing dataset having a high impact of the convergence, wherein the report identifies the discrete portions of the first testing dataset.

Aspect 4. The method of any of Aspects 1 to 3, wherein analyzing the first ML model based on the convergence of the first ML model comprises: determining an impact of the first testing dataset based on the convergence; and identifying discrete portions of the first testing dataset causing the convergence to underperform, wherein the report identifies the discrete portions of the first testing dataset.

Aspect 5. The method of any of Aspects 1 to 4, wherein the discrete portions of the first testing dataset cause the convergence to underperform based on a volume of data used in the training and an extra compute time.

Aspect 6. The method of any of Aspects 1 to 5, wherein noise in annotations in the first testing dataset cause the convergence to user-perform.

Aspect 7. The method of any of Aspects 1 to 6, further comprising: generating second metrics based on the training of the second ML model; and comparing the second metrics to first metrics associated with the first ML model to determine that a first scenario in the first ML model is unresolved in the second ML model, wherein the report identifies that the first scenario was forgotten during training of the second ML model.

Aspect 8. The method of any of Aspects 1 to 7, wherein the first scenario was resolved during the training of the first ML model.

Aspect 9. The method of any of Aspects 1 to 8, further comprising: training a third ML model from the second ML model based on a compute budget associated with an autonomous vehicle with a second testing dataset.

Aspect 10. The method of any of Aspects 1 to 9, wherein the training of the third ML model comprises at least one: training the third ML model with a second testing dataset different from the first testing dataset; and training the third ML model with a different architecture than the second ML model.

Aspect 11. The method of any of Aspects 1 to 10, wherein the first ML model is trained based on a second configuration.

Aspect 12. The method of any of Aspects 1 to 11, wherein training the first ML model based on the second configuration comprises: generating a second training dataset and a third training dataset based on a curriculum for the first ML model to learn; training the first ML model with the second training dataset; and after training the first ML model with the second training dataset, training the first ML model with a third dataset, wherein the second training dataset and the third training dataset are generated based on the curriculum for the first ML model to learn.

Aspect 13. The method of any of Aspects 1 to 12, wherein the second training dataset comprises a first scenario to learn first and the third training dataset comprises at least one scenario of the first scenario.

Aspect 14. The method of any of Aspects 1 to 13, wherein training the first ML model based on the second configuration comprises: identifying at least one annotation in the first testing dataset set to emphasize; training the first ML model with a second training dataset based on the identification of annotations to emphasize.

Aspect 15. The method of any of Aspects 1 to 14, further comprising: generating a second testing dataset from the first testing dataset based on the identification of the annotations to emphasize.

Aspect 16. The method of any of Aspects 1 to 15, wherein a ML model trainer that performs each iteration of the training receives the identification of the annotations to emphasize.

Aspect 17. The method of any of Aspects 1 to 16, wherein the report identifies at least one information group that identifies at least one constraint detected during the training.

Aspect 18. The method of any of Aspects 1 to 17, wherein the at least one information group comprises at least one of a model capacity, a learning category, a scenario imbalance, a target category imbalance, model information, data diversity information, evaluation information, and optimization information.

Aspect 19: A system includes a storage (implemented in circuitry) configured to store instructions and a processor. The processor configured to execute the instructions and cause the processor to: pretrain an uninitialized ML model to yield a first ML model; train the first ML model with a first testing dataset for a first number of iterations based on a first configuration; analyze the first ML model based on a convergence of the first ML model and a previous iteration of training; generate a report based on the analysis of the first ML; and after generating the report, train the first ML model to yield a second ML model.

Aspect 20: The system of Aspect 19, wherein training of the first ML model is performed with a second testing dataset.

Aspect 21: The system of any of Aspects 19 to 20, wherein the processor is configured to execute the instructions and cause the processor to: determine an impact of the first testing dataset based on the convergence; and identify discrete portions of the first testing dataset having a high impact of the convergence, wherein the report identifies the discrete portions of the first testing dataset.

Aspect 22: The system of any of Aspects 19 to 21, wherein the processor is configured to execute the instructions and cause the processor to: determine an impact of the first testing dataset based on the convergence; and identify discrete portions of the first testing dataset causing the convergence to underperform, wherein the report identifies the discrete portions of the first testing dataset.

Aspect 23: The system of any of Aspects 19 to 22, wherein the discrete portions of the first testing dataset cause the convergence to underperform based on a volume of data used in the training and an extra compute time.

Aspect 24: The system of any of Aspects 19 to 23, wherein noise in annotations in the first testing dataset cause the convergence to user-perform.

Aspect 25: The system of any of Aspects 19 to 24, wherein the processor is configured to execute the instructions and cause the processor to: generate second metrics based on the training of the second ML model; and compare the second metrics to first metrics associated with the first ML model to determine that a first scenario in the first ML model is unresolved in the second ML model, wherein the report identifies that the first scenario was forgotten during training of the second ML model.

Aspect 26: The system of any of Aspects 19 to 25, wherein the first scenario was resolved during the training of the first ML model.

Aspect 27: The system of any of Aspects 19 to 26, wherein the processor is configured to execute the instructions and cause the processor to: train a third ML model from the second ML model based on a compute budget associated with an autonomous vehicle with a second testing dataset.

Aspect 28: The system of any of Aspects 19 to 27, wherein the training of the third ML model comprises at least one: train the third ML model with a second testing dataset different from the first testing dataset; and train the third ML model with a different architecture than the second ML model.

Aspect 29: The system of any of Aspects 19 to 28, wherein the first ML model is trained based on a second configuration.

Aspect 30: The system of any of Aspects 19 to 29, wherein the processor is configured to execute the instructions and cause the processor to: generate a second training dataset and a third training dataset based on a curriculum for the first ML model to learn; train the first ML model with the second training dataset; and after training the first ML model with the second training dataset, train the first ML model with a third dataset, wherein the second training dataset and the third training dataset are generated based on the curriculum for the first ML model to learn.

Aspect 31: The system of any of Aspects 19 to 30, wherein the second training dataset comprises a first scenario to learn first and the third training dataset comprises at least one scenario of the first scenario.

Aspect 32: The system of any of Aspects 19 to 31, wherein the processor is configured to execute the instructions and cause the processor to: identify at least one annotation in the first testing dataset set to emphasize; train the first ML model with a second training dataset based on the identification of annotations to emphasize.

Aspect 33: The system of any of Aspects 19 to 32, wherein the processor is configured to execute the instructions and cause the processor to: generate a second testing dataset from the first testing dataset based on the identification of the annotations to emphasize.

Aspect 34: The system of any of Aspects 19 to 33, wherein a ML model trainer that performs each iteration of the training receives the identification of the annotations to emphasize.

Aspect 35: The system of any of Aspects 19 to 34, wherein the report identifies at least one information group that identifies at least one constraint detected during the training.

Aspect 36: The system of any of Aspects 19 to 35, wherein the at least one information group comprises at least one of a model capacity, a learning category, a scenario imbalance, a target category imbalance, model information, data diversity information, evaluation information, and optimization information.

Aspect 37: A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: pretrain an uninitialized ML model to yield a first ML model; train the first ML model with a first testing dataset for a first number of iterations based on a first configuration; analyze the first ML model based on a convergence of the first ML model and a previous iteration of training; generate a report based on the analysis of the first ML; and after generating the report, train the first ML model to yield a second ML model.

Aspect 38: The computer readable medium of Aspect 37, wherein training of the first ML model is performed with a second testing dataset.

Aspect 39: The computer readable medium of any of Aspects 37 to 38, wherein the processor is configured to execute the computer readable medium and cause the processor to: determine an impact of the first testing dataset based on the convergence; and identify discrete portions of the first testing dataset having a high impact of the convergence, wherein the report identifies the discrete portions of the first testing dataset.

Aspect 40: The computer readable medium of any of Aspects 37 to 39, wherein the processor is configured to execute the computer readable medium and cause the processor to: determine an impact of the first testing dataset based on the convergence; and identify discrete portions of the first testing dataset causing the convergence to underperform, wherein the report identifies the discrete portions of the first testing dataset.

Aspect 41: The computer readable medium of any of Aspects 37 to 40, wherein the discrete portions of the first testing dataset cause the convergence to underperform based on a volume of data used in the training and an extra compute time.

Aspect 42: The computer readable medium of any of Aspects 37 to 41, wherein noise in annotations in the first testing dataset cause the convergence to user-perform.

Aspect 43: The computer readable medium of any of Aspects 37 to 42, wherein the processor is configured to execute the computer readable medium and cause the processor to: generate second metrics based on the training of the second ML model; and compare the second metrics to first metrics associated with the first ML model to determine that a first scenario in the first ML model is unresolved in the second ML model, wherein the report identifies that the first scenario was forgotten during training of the second ML model.

Aspect 44: The computer readable medium of any of Aspects 37 to 43, wherein the first scenario was resolved during the training of the first ML model.

Aspect 45: The computer readable medium of any of Aspects 37 to 44, wherein the processor is configured to execute the computer readable medium and cause the processor to: train a third ML model from the second ML model based on a compute budget associated with an autonomous vehicle with a second testing dataset.

Aspect 46: The computer readable medium of any of Aspects 37 to 45, wherein the training of the third ML model comprises at least one: train the third ML model with a second testing dataset different from the first testing dataset; and train the third ML model with a different architecture than the second ML model.

Aspect 47: The computer readable medium of any of Aspects 37 to 46, wherein the first ML model is trained based on a second configuration.

Aspect 48: The computer readable medium of any of Aspects 37 to 47, wherein the processor is configured to execute the computer readable medium and cause the processor to: generate a second training dataset and a third training dataset based on a curriculum for the first ML model to learn; train the first ML model with the second training dataset; and after training the first ML model with the second training dataset, train the first ML model with a third dataset, wherein the second training dataset and the third training dataset are generated based on the curriculum for the first ML model to learn.

Aspect 49: The computer readable medium of any of Aspects 37 to 48, wherein the second training dataset comprises a first scenario to learn first and the third training dataset comprises at least one scenario of the first scenario.

Aspect 50: The computer readable medium of any of Aspects 37 to 49, wherein the processor is configured to execute the computer readable medium and cause the processor to: identify at least one annotation in the first testing dataset set to emphasize; train the first ML model with a second training dataset based on the identification of annotations to emphasize.

Aspect 51: The computer readable medium of any of Aspects 37 to 50, wherein the processor is configured to execute the computer readable medium and cause the processor to: generate a second testing dataset from the first testing dataset based on the identification of the annotations to emphasize.

Aspect 52: The computer readable medium of any of Aspects 37 to 51, wherein a ML model trainer that performs each iteration of the training receives the identification of the annotations to emphasize.

Aspect 53: The computer readable medium of any of Aspects 37 to 52, wherein the report identifies at least one information group that identifies at least one constraint detected during the training.

Aspect 54: The computer readable medium of any of Aspects 37 to 53, wherein the at least one information group comprises at least one of a model capacity, a learning category, a scenario imbalance, a target category imbalance, model information, data diversity information, evaluation information, and optimization information.

What is claimed is:

1. A method of training a machine learning (ML) model, the method comprising:
pretraining an uninitialized ML model to yield a first ML model;
training the first ML model with a first testing dataset for a first number of iterations based on a first configuration;
analyzing the first ML model based on a convergence of the first ML model and a previous iteration of training;
generating a report based on the analysis of the first ML; and
after generating the report, training the first ML model to yield a second ML model.

2. The method of claim 1, wherein training of the first ML model is performed with a second testing dataset.

3. The method of claim 2, wherein analyzing the first ML model based on the convergence of the first ML model comprises:
determining an impact of the first testing dataset based on the convergence; and
identifying discrete portions of the first testing dataset having a high impact of the convergence,
wherein the report identifies the discrete portions of the first testing dataset.

4. The method of claim 2, wherein analyzing the first ML model based on the convergence of the first ML model comprises:
determining an impact of the first testing dataset based on the convergence; and
identifying discrete portions of the first testing dataset causing the convergence to underperform,
wherein the report identifies the discrete portions of the first testing dataset.

5. The method of claim 4, wherein the discrete portions of the first testing dataset cause the convergence to underperform based on a volume of data used in the training and an extra compute time.

6. The method of claim 4, wherein noise in annotations in the first testing dataset cause the convergence to user-perform.

7. The method of claim 1, further comprising:
generating second metrics based on the training of the second ML model; and
comparing the second metrics to first metrics associated with the first ML model to determine that a first scenario in the first ML model is unresolved in the second ML model,
wherein the report identifies that the first scenario was forgotten during training of the second ML model.

8. The method of claim 7, wherein the first scenario was resolved during the training of the first ML model.

9. The method of claim 1, further comprising:
training a third ML model from the second ML model based on a compute budget associated with an autonomous vehicle with a second testing dataset.

10. The method of claim 9, wherein the training of the third ML model comprises at least one:
training the third ML model with a second testing dataset different from the first testing dataset; and
training the third ML model with a different architecture than the second ML model.

11. The method of claim 1, wherein the first ML model is trained based on a second configuration.

12. The method of claim 11, wherein training the first ML model based on the second configuration comprises:
generating a second training dataset and a third training dataset based on a curriculum for the first ML model to learn;
training the first ML model with the second training dataset; and
after training the first ML model with the second training dataset, training the first ML model with a third dataset, wherein the second training dataset and the third training dataset are generated based on the curriculum for the first ML model to learn.

13. The method of claim 12, wherein the second training dataset comprises a first scenario to learn first and the third training dataset comprises at least one scenario of the first scenario.

14. The method of claim 11, wherein training the first ML model based on the second configuration comprises:
identifying at least one annotation in the first testing dataset set to emphasize;
training the first ML model with a second training dataset based on the identification of annotations to emphasize.

15. The method of claim 14, further comprising:
generating a second testing dataset from the first testing dataset based on the identification of the annotations to emphasize.

16. The method of claim 15, wherein a ML model trainer that performs each iteration of the training receives the identification of the annotations to emphasize.

17. The method of claim 1, wherein the report identifies at least one information group that identifies at least one constraint detected during the training.

18. The method of claim 17, wherein the at least one information group comprises at least one of a model capacity, a learning category, a scenario imbalance, a target category imbalance, model information, data diversity information, evaluation information, and optimization information.

19. A system comprising:
one or more processors; and
at least one non-transitory computer-readable medium having stored thereon instructions that, when executed by the one or more processors, cause the one or more processors to:
pretrain an uninitialized ML model to yield a first ML model;
train the first ML model with a first testing dataset for a first number of iterations based on a first configuration;
analyze the first ML model based on a convergence of the first ML model and a previous iteration of training;
generate a report based on the analysis of the first ML; and
after generating the report, train the first ML model to yield a second ML model.

20. The system of claim 19, wherein training of the first ML model is performed with a second testing dataset, and wherein analyzing the first ML model based on the convergence of the first ML model comprises:
determining an impact of the first testing dataset based on the convergence; and
identifying discrete portions of the first testing dataset having a high impact of the convergence,
wherein the report identifies the discrete portions of the first testing dataset.
